(19) United States
(12) Patent Application Publication
(10) Pub. No.: US 2024/0403706 A1
(43) Pub. Date: Dec. 5, 2024

(54) ACTIVE MULTIFIDELITY LEARNING FOR LANGUAGE MODELS

(71) Applicant: INTUIT INC., Mountain View, CA (US)

(72) Inventors: Jiaxin ZHANG, Mountain View, CA (US); Kamalika DAS, Saratoga, CA (US); Sricharan Kallur Palli KUMAR, Fremont, CA (US)

(21) Appl. No.: 18/616,315

(22) Filed: Mar. 26, 2024

Related U.S. Application Data
(60) Provisional application No. 63/505,189, filed on May 31, 2023.

(51) Int. Cl. G06N 20/00

(52) U.S. Cl. CPC G06N 20/00

(57) ABSTRACT

Aspects of the present disclosure provide techniques for active multifidelity machine learning. Embodiments include selecting, based on one or more criteria, a first subset of unlabeled training data for manual review and a second subset of unlabeled training data for providing to a pre-trained machine learning model for automated labeling. Embodiments include receiving manual label data for the first subset of unlabeled training data. Embodiments include providing inputs to the pre-trained machine learning model based on a subset of the manual label data and the second subset of training data. Embodiments include receiving, as outputs from the pre-trained machine learning model, automated label data for the second subset of unlabeled training data. Embodiments include generating a training data set for a target machine learning model based on the set of unlabeled training data, the manual label data, and the automated label data.

### RELATED APPLICATIONS

This application claims the benefit of U.S. Provisional Application No. 63/505,189, entitled “ACTIVE MULTIFIDELITY LEARNING FOR LANGUAGE MODELS,” by the same inventors, filed 31 May 2023, the contents of which are incorporated herein in their entirety.

### INTRODUCTION

Aspects of the present disclosure relate to techniques for active multifidelity learning for machine learning models. In particular, embodiments involve a dynamic machine learning process where high fidelity manual labeling and low fidelity automated labeling by machine learning models are combined in an optimized manner for improved performance.

### BACKGROUND

Every year millions of people, businesses, and organizations around the world utilize software applications to assist with countless aspects of life. Machine learning models are increasingly relied upon to provide predictions and analysis of data related to such software applications, such as to assist in making automated determinations, to predict user behavior, to classify data, to select or generate content to provide to users, and/or the like.

Training and utilization of machine learning models can be a resource-intensive, expensive, and/or time-consuming process. In many cases, there may be minimal training data available, and generation of new training data is generally a lengthy and inefficient process. Furthermore, utilization of pre-trained machine learning models (e.g., provided by third parties) may be associated with many drawbacks, such as the large amount of computing resources generally required to use such models, the lack of domain-specific training of such models, security concerns, costs, lack of access to source code and/or underlying logic, poor explainability and/or auditability, and/or the like.

What is needed are improved techniques for efficiently training and using machine learning models.

### BRIEF SUMMARY

Certain embodiments provide a method for active multifidelity machine learning. The method generally includes: receiving a set of unlabeled training data; selecting, based on one or more criteria, a first subset of the set of unlabeled training data for providing to one or more users for manual review and a second subset of the set of unlabeled training data for providing to a pre-trained machine learning model for automated labeling; receiving manual label data for the first subset of the set of unlabeled training data; providing inputs to the pre-trained machine learning model based on a subset of the manual label data and the second subset of the set of unlabeled training data; receiving, as outputs from the pre-trained machine learning model in response to the inputs, automated label data for the second subset of the set of unlabeled training data; generating a training data set for a target machine learning model based on the set of unlabeled training data, the manual label data, and the automated label data, wherein the training data set is used to fine-tune the target machine learning model through a supervised learning process by which the target machine learning model is iteratively adjusted based on the training data set.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of active multifidelity machine learning, as described herein.

FIG. 2 depicts an example dynamic allocation of different modes of label generation for active multifidelity machine learning, as described herein.

FIG. 3 depicts an example of exploration and exploitation related to active multi-fidelity machine learning, as described herein.

FIG. 4 depicts example operations related to active multifidelity machine learning, as described herein

FIG. 5 depicts an example processing system related to active multifidelity machine learning, as described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for active multifidelity machine learning.

Embodiments described herein involve a dynamic and iterative process for generating labeled training data based on both “high fidelity” manual labeling and “low fidelity” automated labeling performed by a pre-trained machine learning model, including the use of in-context learning by which manual labels are used to improve the automated labels, and using the labeled training data to fine-tune or train a target machine learning model.

Machine-learning models allow computing systems to improve and refine functionality without explicitly being programmed. Given a set of training data, a machine learning model can generally generate and refine a function that determines a target attribute value based on one or more input features. For example, if a set of input features describes an automobile and the target value is the automobile's gas mileage, a machine learning model can be trained to predict gas mileage based on the input features, such as the automobile's weight, tire size, number of cylinders, coefficient of drag, and engine displacement.

The predictive accuracy a machine learning model achieves ultimately depends on many factors. Ideally, training data for the machine learning model should be representative of the population for which predictions are desired (e.g., unbiased and correctly labeled). In addition, training data should include a substantive number of training instances relative to the number of features on which predictions are based and relative to the range of possible values for each feature.

Generation of training data is often an expensive and inefficient process, particularly in the amounts that are generally needed to train models for high levels of accuracy. As such, large pre-trained models, such as provided by third parties and trained based on large sets of training data that are not specific to a particular domain, are often utilized rather than training a model for a specific domain. However, the use of such models may have notable drawbacks, such as the large amount of computing resources generally required to use such models, the lack of domain-specific training of such models, security concerns, costs, lack of access to source code and/or underlying logic, poor explainability and/or auditability, and/or the like.

Techniques described herein overcome these challenges by using a pre-trained model in conjunction with manual labeling in an intelligent, multi-fidelity learning process to generate training data for use in fine-tuning a target machine learning model that is optimized for a particular domain or purpose. Fine-tuning generally refers to a process by which parameters of a pre-trained machine learning model are trained on new training data (e.g., specific to a particular domain or purpose). Thus, references to “training” herein may also refer to fine-tuning.

According to certain embodiments, the target machine learning model is a smaller, more focused model than the large pre-trained machine learning model used for automated labeling of training data. For example, the target machine learning model may have fewer parameters than the pre-trained machine learning model. In one particular example, the pre-trained machine learning model is a large language model such as a generative pre-trained (GPT) model, and the target machine learning model is a smaller language model, such as the Databricks® Dolly model. The target machine learning model may be trained or fine-tuned for a particular domain or purpose using training data that is generated using techniques described herein.

An unlabeled data pool may include sets of input features that have not yet been labeled for use as training data. For example, if a target machine learning model is to be used for predicting content that is relevant to a user based on input features that describe the user (e.g., including various user attributes, such as the user's previous activities within a software application, a length of time the user has been using the software application, an occupation of the user, and/or the like), the unlabeled data pool may include sets of input features describing users without labels indicating content that is relevant to those users.

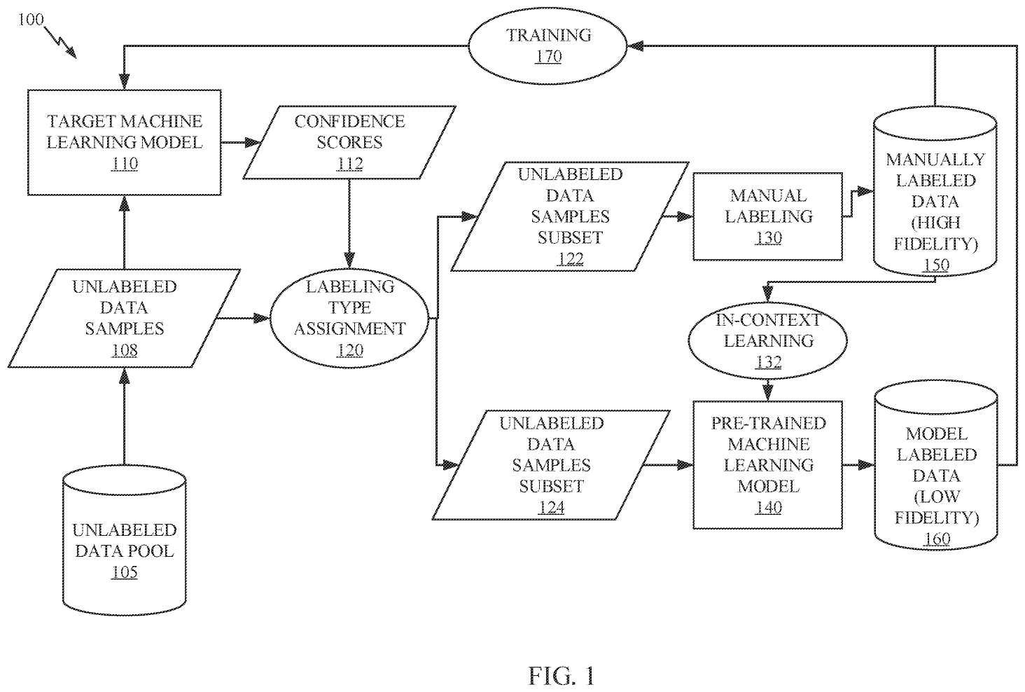

In some embodiments, as described in more detail below with respect to FIG. 1, subsets of the unlabeled data in the unlabeled data pool are selected for processing in each of a plurality of iterations by which labels are applied to the unlabeled data. In an example, for a given iteration, a subset of unlabeled data is selected, and a data labeling engine intelligently determines which items in the subset to provide to a user for manual labeling and which items in the subset to provide to the pre-trained machine learning model for automated labeling. For instance, all or some items in the subset may first be provided to the target machine learning model, and the target machine learning model may output a prediction for each item in association with a confidence score for the prediction (e.g., indicating how confident the target machine learning model is about the prediction). In some embodiments, if the target machine learning model outputs a prediction for a given item with a confidence score above a particular threshold (e.g., a high threshold, such as 95%), then the data labeling engine may determine not to provide that given item to the user or to the pre-trained machine learning model for labeling, as the target machine learning model is likely already trained based on data that is similar to that given item.

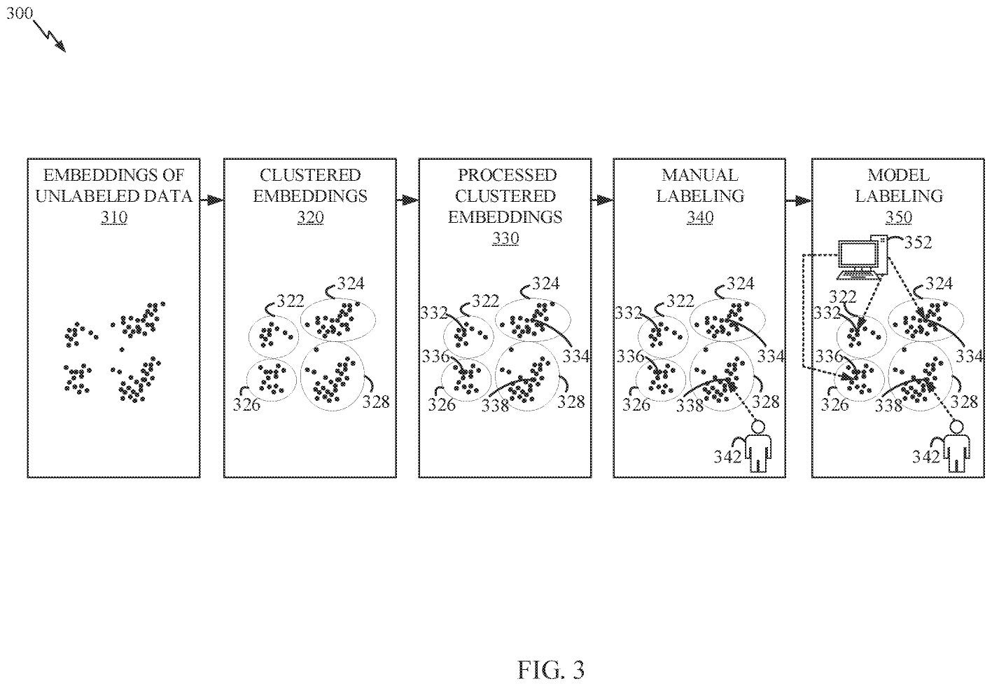

In certain cases, items for which the target machine learning model outputs a low confidence score (e.g., a confidence score below a first threshold) may be selected for manual labeling while items for which the target machine learning model outputs a higher confidence score (e.g., above the first threshold) may be selected for automated labeling by the pre-trained machine learning model. As described in more detail below with respect to FIG. 3, selection of unlabeled data items for manual or automated labeling may be further based on clustering, such as applying a clustering algorithm to a group of unlabeled data and selecting cluster centers (e.g., items that are represented by points near the centers of clusters) for labeling. In one example, cluster centers for which the target machine learning model outputs a low confidence score are selected for manual labeling while cluster centers for which the target machine learning model outputs a higher confidence score are selected for automated labeling.

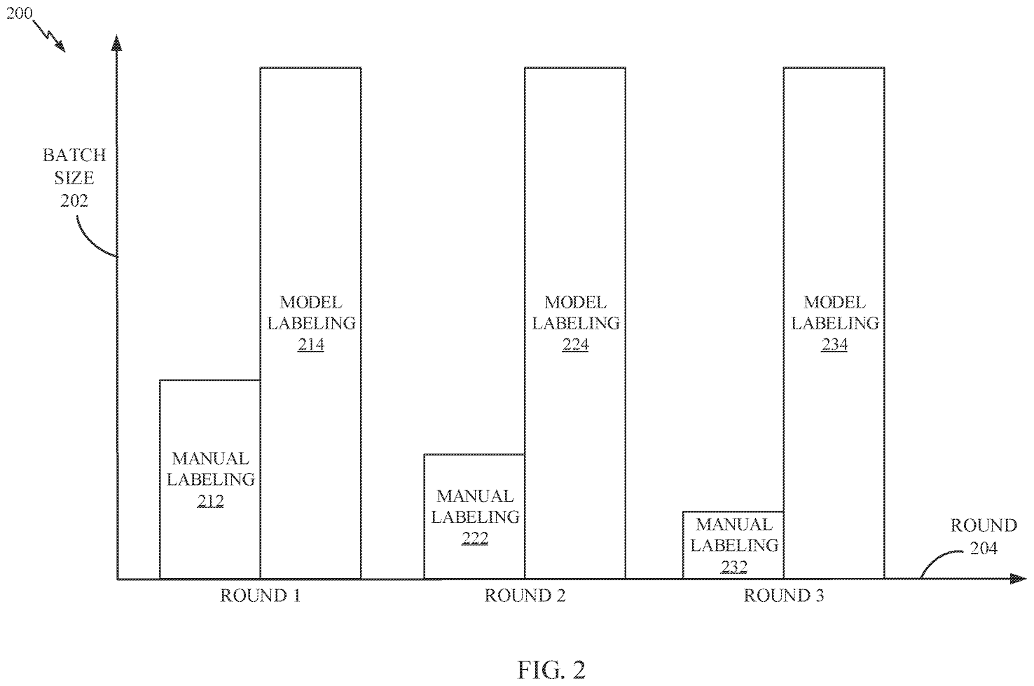

In many cases, it may be advantageous to select a smaller set of unlabeled data for manual labeling relative to a larger set of unlabeled data that is selected for automated labeling during each iteration. As described in more detail below with respect to FIG. 2, the amount of unlabeled data selected for manual labeling relative to the amount of unlabeled data selected for automated labeling may get increasingly smaller with each iteration, as the manually-labeled data set increases.

In-context learning further allows the automated labeling process to be improved in real-time or near real-time based on the manual labeling that occurs during each iteration. In an example, during a given iteration, a first subset of unlabeled data is provided to a user for manual labeling, and manually-applied labels are received in response. The received manually-provided labels may then be provided to the pre-trained machine learning model along with a second subset of unlabeled data that was selected for automated labeling, and the manually-provided labels may assist the pre-trained machine learning model in determining automated labels for the second subset of unlabeled data. This concept may be referred to as “few shot learning.” In few shot learning, a pre-trained machine learning model that has not necessarily been trained for a specific domain or purpose is provided with a relatively small number (e.g., relative to the amount of training data that is used to train the model overall) of labeled training data instances for that specific domain or purpose in order to prime the pre-trained machine learning model to make a prediction for a given set of input features relating to that specific domain or purpose. For example, the relatively small number of training data instances may be provided as part of a prompt to the pre-trained machine learning model along with the input features for which a prediction or inference is being requested, and the pre-trained machine learning model uses the relatively small number of training data instances as in-context reference points that assist in making a prediction based on the input features. Thus, according to techniques described herein, the high-fidelity manual label data, which is highly reliable, is used to further improve the generation of the generally lower-fidelity automated label data during each iteration, thus resulting in an overall set of labeled data that is reliable and yet generated more efficiently than the sole use of manual labeling.

At the end of each iteration, the manually-applied labels and the automatically-generated labels are used to produce a set of labeled training data, and the set of labeled training data is used to re-train the target machine learning model. With each subsequent iteration, the accuracy of the target machine learning model improves and the overall amount of manual label data available increases, thus resulting in fewer unlabeled training data items being selected for manual labeling (e.g., based on confidence scores output by the target machine learning model being higher) and higher levels of accuracy for the automated labeling process (e.g., as a result of having a larger number of manual labels to use for in-context learning). Thus, the expensive and time-consuming manual labeling process is minimized, the efficient but conventionally low-fidelity automated labeling process is maximized and improved for higher levels of accuracy, and a large number of reliable labeled training data instances are generated in a time-efficient and resource-efficient manner. As a result, the target machine learning model is fine-tuned for high accuracy with respect to the target domain or purpose and may be used to generate accurate predictions for the target domain or purpose without requiring the high levels of computing resource utilization and other drawbacks that would be associated with ongoing use of the pre-trained machine learning model, while benefiting by way of the automated label generation process from the large amount of training data that was used to train the pre-trained machine learning model.

Techniques described herein improve the functioning of a computer by reducing the amount of computing resources required to generate high-quality training data and to train and run a highly-accurate machine learning model for a particular domain or purpose. Furthermore, techniques described herein improve the technical field of machine learning by efficiently producing large amounts of reliable training data that could not be produced in such an efficient manner using conventional techniques, by improving the accuracy of a target machine learning model through an iterative training process in which manual labeling and automated labeling are combined in an intelligent manner for optimal reliability, and by allowing relatively smaller amounts of manual label data to be used in-context to improve the accuracy of automated labeling.

Machine learning models trained or fine-tuned using techniques described herein may produce results that are more accurate than those produced by conventional machine learning models, thereby resulting in optimized automated determinations that are based on such results and, consequently, the avoidance of utilizing computing resource that would otherwise have been expended in association with suboptimal automated determinations.

### Example of Active Multifidelity Machine Learning

FIG. 1 is an illustration 100 of an example of active multifidelity machine learning, as described herein.

Illustration 100 includes an unlabeled data pool 105, which generally includes input features related to entities (e.g., corresponding to inputs accepted by target machine learning model 110) that have not been labeled for use as training data.

Target machine learning model 110 and pre-trained machine learning model 140 generally represent machine learning models. In some embodiments, pre-trained machine learning model 140 has a larger number of parameters than target machine learning model 110, and has been trained on a larger training data set than target machine learning model 110. Pre-trained machine learning model 140 may require larger amounts of computing resources for its use than target machine learning model 110. According to certain embodiments, pre-trained machine learning model 140 is trained on a large training data set that is nor specific to a target domain or purpose, while target machine learning model 110 is trained or fine-tuned for such a target domain or purpose. In some embodiments, target machine learning model 110 may be pre-trained, but may be smaller than pre-trained machine learning model 140.

There are many different types of machine learning models that can be used in embodiments of the present disclosure, such as for pre-trained machine learning model 140 and/or target machine learning model 110. For example, one or more of these models may be a neural network or a tree-based model. One or more of these models may also be an ensemble of several different individual machine learning models. Such an ensemble may be homogenous (i.e., using multiple member models of the same type) or non-homogenous (i.e., using multiple member models of different types).

Neural networks, for example, generally include a collection of connected units or nodes called artificial neurons. The operation of neural networks can be modeled as an iterative process. Each node has a particular value associated with it. In each iteration, each node updates its value based upon the values of the other nodes, the update operation typically consisting of a matrix-vector multiplication. The update algorithm reflects the influences on each node of the other nodes in the network. In some cases, a neural network comprises one or more aggregation layers, such as a softmax layer.

In some embodiments, training of a machine learning model is a supervised learning process that involves providing training inputs (e.g., representing an entity) as inputs to a machine learning model. The machine learning model processes the training inputs and outputs predictions (e.g., indications of classifications of entities represented by the training inputs or some other predicted attributes of the entities) based on the training inputs. The predictions are compared to the known labels associated with the training inputs (e.g., labels generated using the active multifidelity learning techniques described herein) to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for a machine learning model, such as based on validation data and test data, as is known in the art.

In one example, pre-trained machine learning model 140 is a large language model such as a GPT model and target machine learning model 110 is a smaller language model (e.g., having fewer parameters than target machine learning model 110), such as the Databricks® Dolly model. Pre-trained machine learning model 140 may be a very large model, such as including billions or even trillions of parameters, and may be resource-inefficient to use for all inferencing tasks. Target machine learning model 110, on the other hand, may be a smaller model, such as having millions or billions fewer parameters.

Models of a very large scale (e.g., pre-trained machine learning model 140) often require specialized hardware, massive-scale training data, and extensive computational power, which are inaccessible for most product or research teams. In addition, the generalizability of such models is predominantly decided by the scope of the underlying pre-training data. In fact, many such models do not perform well out of the box in many real-world domains where specialized knowledge beyond the standard fields of pre-training is required (i.e., domain shifts).

Active multifidelity learning techniques described herein aim at identifying the best acquisition strategy that balances between low-fidelity automatic model-based annotations and high-fidelity human annotations to maximize model performance given limited annotation budgets. The high human annotation cost in domain-specific tasks can be greatly reduced by employing techniques described herein, which utilize fewer human annotations combined with cheaper, more efficient model-based annotations to achieve competitive performance.

As an alternative to general-purpose large language models, practitioners often find small domain-specific language models (e.g., target machine learning model 110) to be more favorable, as they require less training data and are faster to compute, leading to faster development cycles and lower operating costs, including lower computing resource utilization. A common practice of developing such models is through the classic pre-training and then fine-tuning paradigm. Unfortunately, to achieve comparable performance as general purpose large language models, tuning small language models generally requires high-quality manual annotations on target domain data, which in many fields requires extensive human effort and expert knowledge, making supervised fine-tuning very expensive.

One promising approach to alleviate human annotation efforts is to leverage large language models as knowledge bases for automatically annotating new data. Unfortunately, such an approach is susceptible to the misinformation of large language models through hallucination, which risks generating unreliable or falsified labels and will, in turn, demolish the model's utility for high-stakes applications like healthcare and finance, where the truth is of utmost importance.

According to embodiments of the present disclosure, active multifidelity learning achieves cost-effective development of domain-specific language models, as illustrated in FIG. 1. For example, because different data samples inherently exhibit different levels of difficulty for learning, it is not necessary to request human labeling for every sample. By discerning each sample's difficulty level, the majority of labeling tasks can be delegated to automatic annotation tools such as the use of pre-trained machine learning model 140 while exclusively assigning a limited number of highly uncertain samples to human annotators, thereby reducing human effort significantly while still maintaining high label quality.

Accordingly, an active multifidelity learning process may involve a series of iterations, and in each iteration a set of unlabeled data samples 108 are selected (e.g., randomly) from unlabeled data pool 105. Unlabeled data samples 108 are provided as inputs to target machine learning model 110, and target machine learning model 110 outputs confidence scores 112 (e.g., along with predicted labels) for each unlabeled data sample 108. Confidence scores 112 are used in a labeling type assignment 120 process to determine whether to assign each of unlabeled data samples 108 to a manual labeling 130 process or to pre-trained machine learning model 140 for automated labeling.

At labeling type assignment 120, a first unlabeled data samples subset 122 is selected for manual labeling 130 and a second unlabeled data samples subset 124 is selected for automated labeling by pre-trained machine learning model 140. In some embodiments, the first unlabeled data samples subset 122 comprises a subset of unlabeled data samples 108 for which a confidence score 112 output by target machine learning model 110 is below a threshold and the second unlabeled data samples subset 124 comprises a subset of unlabeled data samples 108 for which a confidence score 112 output by target machine learning model 110 is above the threshold. In certain embodiments, at labeling type assignment, any unlabeled data samples 108 for which a confidence score 112 output by target machine learning model 110 is above a high threshold (e.g., a second threshold that is higher than the threshold used to select between manual labeling and automated labeling) may not be selected for either manual labeling or automated labeling, and may be removed from unlabeled data pool 105 altogether (e.g., because target machine learning model 110 is already trained to handle these unlabeled data samples).

As described in more detail below with respect to FIG. 3, clustering may be performed on unlabeled data samples 108, and the clustering may be used at labeling type assignment 120. For example, cluster centers (e.g., unlabeled data centers that are positioned at or near the center of clusters) may be selected as unlabeled data samples subset 122 and/or unlabeled data samples subset 124 in order to obtain a diverse labeled training data set that provides broad coverage of the concepts within unlabeled data pool 105.

Unlabeled data samples subset 122 selected for manual labeling may be smaller than unlabeled data samples subset 124 selected for automated labeling by pre-trained machine learning model 140. For example, unlabeled data samples subset 122 may include a given number of cluster centers with the lowest confidence scores 112 or with confidence scores 112 below a threshold, and unlabeled data samples subset 124 may include a given (e.g., larger) number of cluster centers with higher confidence score or with confidence scores above the threshold. In some embodiments, as described in more detail below with respect to FIG. 2, the size of unlabeled data samples subset 122 may decrease with each subsequent iteration, as the overall pool of manually-labeled data increases.

At manual labeling 130, unlabeled data samples subset 122 are provide to a human annotator for manual labeling, and manual labels are received in response. For example, the human annotator may review each of unlabeled data samples subset 122 and provide a label in response via a user interface. The manual labels are associated with unlabeled data samples subset 122, and are stored as manually labeled data 150, which includes high fidelity labeled training data. Furthermore, manually labeled data 150 is used to perform in-context learning 132. For example, in-context learning 132 may involve providing manually labeled data 150 to pre-trained machine learning model 140 as examples that are specific to a domain or purpose related to unlabeled data samples subset 124 prior to pre-trained machine learning model 140 generating automated labels for unlabeled data samples subset 124. In some embodiments, as is known in the art, some or all of the manually labeled samples in manually labeled data 150 are provided to pre-trained machine learning model 140 via a prompt.

Pre-trained machine learning model 140 generates automated labels for unlabeled data samples subset 124, such as based on in-context learning 132. In an example, each respective unlabeled data sample in unlabeled data samples subset 124 is provided to pre-trained machine learning model 140, and pre-trained machine learning model 140 outputs a respective automated label for each respective unlabeled data sample based on in-context learning 132.

Automated labels output by pre-trained machine learning model 140 are associated with unlabeled data samples subset 124 and stored as model labeled data 160, which is low fidelity (e.g., lower fidelity than manually labeled data 150), although model labeled data 160 is significantly higher-fidelity than it would have been without in-context learning 132.

Manually labeled data 150 and model labeled data 160 are both used to perform fine-tuning 170 on target machine learning model 10. For example, fine-tuning 170 may involve providing training inputs to target machine learning model 110, receiving outputs from target machine learning model 110 in response to the training inputs, comparing the outputs to the labels associated with the training inputs, and iteratively adjusting parameters of target machine learning model based on the comparing (e.g., to optimize a cost function). After each iteration of fine-tuning 170, target machine learning model 110 will exhibit better performance for the target domain or purpose. As such, confidence scores 112 should incrementally increase for each subsequent iteration of the active multifidelity process shown in FIG. 1, thus resulting in fewer unlabeled data samples being selected for manual labeling 130 with each iteration, and potentially fewer unlabeled data samples needing to be labeled at all with each iteration. As such, the active multifidelity learning process described herein provides an incrementally self-improving feedback loop that continues to produce reductions in computing resource utilization, reductions in cost and time, and improved accuracy. Embodiments of the present disclosure may be regarded as a synergy between fine-tuning and knowledge distillation under sparse human supervision.

### Example of Dynamic Allocation of Different Modes of Label Generation

FIG. 2 is an example chart 200 depicting dynamic allocation of different modes of label generation for active multifidelity machine learning, as described herein.

Chart 200 depicts batch size 202 (e.g., representing an amount of unlabeled data samples selected for each type of labeling) versus round 204 (e.g., representing a series of subsequent rounds or iterations of the active multifidelity learning process described above with respect to FIG. 1).

As shown in chart 200, the amount of manual labeling 212 in the first round is larger than the amount of manual labeling 222 in the second round, and the amount of manual labeling 222 in the second round is larger than the amount of manual labeling 232 in the third round. By contrast, the amount of model labeling 214 (e.g., automated labling by a pre-trained machine learning model) remains generally constant between each round. It is noted that the units of batch size 202 are not important, and graph 200 is included to depict the relative amounts of manual labeling and model labeling in each round. Furthermore, graph 200 is meant to provide an example generally representation of relative amounts of manual labeling and model labeling in series of subsequent rounds, and is not meant to limit techniques described herein to any particular amounts or relative amounts.

### Example of Exploration and Exploitation Related to Active Multifidelity Machine Learning

FIG. 3 is an illustration 300 of an example of exploration and exploitation related to active multifidelity machine learning, as described herein.

Embodiments of the present disclosure introduce an exploration-exploitation query strategy, wherein human annotations emphasize exploitation geared toward maximizing informativeness through uncertainty sampling while automated model-based annotations concentrate on exploration to foster diversity and improve representativeness through diversity sampling. The general idea is a two-stage selection: executing 1) diversity sampling, e.g., selecting cluster centers to reduce intra-iteration redundancy, and 2) uncertainty sampling, e.g., selecting instances with the least confidence, to avoid inter-iteration redundancy.

First, at stage 310, embeddings of unlabeled data are determined. For example, embeddings of unlabeled data samples from unlabeled data pool 105 of FIG. 1 may be determined. An embedding generally refers to a vector representation of an entity that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities. In one example, the embedding model comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and GloVe embeddings. These are included as examples, and other techniques for generating embeddings are possible.

At stage 320, the embeddings are clustered, such as by applying a clustering algorithm to the embeddings generated at stage 310. The clustering algorithm may be, for example, k-means or another clustering algorithm. Clusters 322, 324, 326, and 328 are generated at stage 320.

At stage 330, the clustered embeddings are processed in order to determine which unlabeled data samples should be selected for manual labeling and which unlabeled data samples should be selected for model labeling. For example, cluster centers 332, 334, 336, and 338 may be identified (e.g., by determining which embeddings are closest to the centers of clusters 322, 324, 326, and 328) and the corresponding unlabeled data samples may be provided to the target machine learning model in order to determine confidence scores. In an example, cluster centers that correspond to confidence scores below a threshold are selected for manual labeling while cluster centers corresponding to confidence scores above the threshold are selected for model labeling. In other embodiments, a given number of cluster centers are selected for manual labeling (e.g., the cluster centers that correspond to the lowest n confidence scores) and another given number of cluster centers are selected for model labeling (e.g., the cluster centers that correspond to the next highest m confidence scores after the lowest n confidence scores). These techniques are included as examples, and other techniques are possible.

At stage 340, manual labeling is performed for the selected unlabeled data samples. For example, a user 342 may manually label an unlabeled data sample that corresponds to cluster center 338. Results of manual labeling at stage 340 may be used to perform in-context learning for improved performance of model labeling at stage 350.

At stage 350, model labeling is performed for the corresponding selected unlabeled data samples. For example, a pre-trained machine learning model running on a computing device 352 may generate automated labels for the unlabeled data samples that correspond to cluster centers 332, 334, and 336.

### Example Algorithm for Active Multifidelity Machine Learning

Given a total annotation budget [symbol] and a computational cost [symbol] (e.g., costs for fine-tuning, inference, and query), embodiments of the present disclosure aim to fine-tune a small language model (LM), such as target machine learning model 110 of FIG. 1, f (x; θ*): [symbol] → [symbol] with pre-trained parameters θ* on a downstream task by annotating samples from an unannotated data pool [symbol] ={x}ᵢ₌₁^{U} to constitute the annotated sample set [symbol] (| [symbol] |≤ [symbol] and initially [symbol] =ø) such that the model's performance is maximized. In the multi-fidelity setting, the annotated set contains a human-annotated subset [symbol] _{H} and a model-annotated (e.g., by a large language model, such as pre-trained machine learning model 140 of FIG. 1) subset [symbol] _{G}, SO [symbol] = [symbol] _{H}∪ [symbol] _{G}. Similarly, the total annotation budget is composed of human annotation budget [symbol] _{H} and large language model (LLM) annotation budget [symbol] _{G} (By is typically much smaller than [symbol] _{G}), i.e., [symbol] = [symbol] _{H}+ [symbol] _{G}.

To solve for the best annotation strategy to maximize annotation and computation efficiency, the annotation acquisition process may be posed as a multi-fidelity learning problem with interactions allowed for R rounds (e.g., corresponding to rounds 204 of FIG. 2, each of which may correspond to illustration 100 of FIG. 1). In the r-th round (1≤r≤R), a set of instances [symbol] is queried, and acquired samples [symbol] from the unannotated pool are selected to add annotation, i.e., [symbol] = [symbol] \ [symbol] , and the target model f is fine-tuned on [symbol] to update θ^{(r)}. The goal is to minimize the empirical risk [symbol] (f) of the final LM f (x; θ^{(R)}) on the downstream task, subject to preset annotation budget and computational cost constraints.

Certain embodiments involve initializing the multi-fidelity learning loop by randomly selecting a small set of samples [symbol] from the unannotated set [symbol] to be annotated by human annotators. The pre-trained LM with parameters θ* is then tuned on the initial annotated dataset:

$${θ}^{( 0 )} = arg {min}_{θ} * \frac{1}{\vert {𝒜}_{H}^{0} \vert} {\sum }_{( {x}_{i} , {y}_{i} ) ∈ {𝒜}_{H}^{0}} ℒ ( f ( {x}_{i} ; {θ}^{*} ) , {y}_{i} ) , i = 1 , … , {n}_{s} \qquad ( 1 )$$

where [symbol] is the loss function, e.g., cross-entropy for classification, and ns is the annotation size. This enables the uncertainty score of the target LM to be initially updated on domain-specific data, which helps to mitigate the cold-start issues (e.g., when no training data or minimal training data is available for a given domain or purpose).

After model initialization, query samples are selected from the unannotated pool [symbol] = [symbol] \ [symbol] for either human or LLM annotation. Existing methods for labeling unannotated data (e.g., using manual labeling or model labeling, but generally not both) often consider the entire unannotated pool during sampling. These approaches scale poorly to large unlabeled datasets, as acquiring informative samples usually involves making inferences or executing clustering, which can be time-consuming if these operations were to be computed over all data samples. Thus, for any interaction round r, techniques described herein involve randomly sub-sampling from [symbol] to obtain a smaller candidate set [symbol] where the acquisition strategy can be efficiently computed.

In the r-th round of interactive fine-tuning, techniques described herein involve first performing the exploration-exploitation query (EEQ) strategy [symbol] (described above with respect to FIG. 3) to determine the human annotation set [symbol] and LLM annotation set [symbol] from the sub-sampled unannotated pool [symbol] . Then the interactive multi-fidelity learning can be solved by minimizing the following total loss objective:

$${ℒ}_{total} = \frac{1}{\vert {𝒜}_{H}^{r} \vert} {\sum }_{( {x}_{i} , {y}_{i} ) ∈ {𝒜}_{H}^{r}} ℒ ( f ( {x}_{i} ; {θ}^{( r )} ) , {y}_{i} ) + \frac{1}{\vert {𝒜}_{G}^{r} \vert} {\sum }_{( {x}_{j} , {y}_{j} ) ∈ {𝒜}_{G}^{r}} ℒ ( f ( {x}_{j} ; {θ}^{( r )} ) , {y}_{j} ) \qquad ( 2 )$$

Unlike the existing approaches that use simultaneous annotation with equal batch sizes for each round, embodiments of the present disclosure emphasize the importance of annotation order (human first and then LLM) and variable batch sizes for each query step, and identify the following two example designs that improve query efficiency and annotation effectiveness.

Design 1—In-context learning with similarity-based prompt retrieval. According to the annotation budget [symbol] and [symbol] , [symbol] and [symbol] instances are acquired for human and LLM annotators respectively. Acquired samples [symbol] are first annotated by humans, [symbol] is obtained, and then an update is performed to the human-annotated set [symbol] = [symbol] ∪ [symbol] . When using the LLM to automatically generate annotations for new data, a few examples are retrieved from the current human-annotated set [symbol] as in-context examples for improving the predicted annotation quality, as described above with respect to FIG. 1. Leveraging recent advances in prompt retrieval, embodiments of the present disclosure involve computing embeddings from all annotated samples using (e.g., using a Sentence-BERT model), and finding the most similar examples for each queried instance measured by cosine similarity. This design improves in-context learning by better utilizing human supervision, which empirically helps to further improve the accuracy and robustness of LLM annotations.

Design 2—Variable batch-size query. Certain embodiments involve a variable batch-size query strategy that puts more human budgets towards the initial steps of the learning process to annotate the most uncertain instances and gradually decreases the batch sizes until the total budget is reached, as described above with respect to FIG. 2. Another benefit of this design is that acquiring more human-annotated examples in the early stage enables access to a larger pool of high-fidelity samples for conducting similarity-based prompt retrieval, which further improves the in-context learning performance and stabilizes the LLM annotations. Inspired by infinite geometric series, certain embodiments involve a budget decay scheme and thus set the human annotation budget for the r-th round to be [symbol] = [symbol] /2^{r} and iterate until the total budget is reached, i.e.:

$$\frac{{ℬ}_{H}}{{2}^{1}} + \frac{{ℬ}_{H}}{{2}^{2}} + \frac{{ℬ}_{H}}{{2}^{3}} + \frac{{ℬ}_{H}}{{2}^{4}} + … + \frac{{ℬ}_{H}}{{2}^{r}} = {\sum }_{r = 1}^{R} {( \frac{1}{2} )}^{r} {ℬ}_{H} \to {ℬ}_{H} . \qquad ( 3 )$$

Note that the residual budget after R rounds will be jointly applied to the last round.

Leveraging the benefits of novel designs, techniques described herein efficiently acquire larger amounts of high-quality data [symbol] annotated by LLMs (e.g., a GPT model). The next step is to update the annotated sample set in the r-th round [symbol] = [symbol] ∪ [symbol] and unannotated data pool [symbol] = [symbol] \ [symbol] . Then the target model f is fine-tuned using the annotated sample set (xᵢ, yᵢ)∈ [symbol] and the model parameters θ^{(r)} is updated.

Thus, certain embodiments of the present disclosure may involve the following operations for the variables of unannotated data pool [symbol] , target LM model f, query strategy [symbol] , annotation budget [symbol] Initialization: [symbol] =ø, θ=θ⁽⁰⁾ on [symbol] rounds r=1, . . . , R [symbol] ←Extract from [symbol] by random sub-sampling [ [symbol] , [symbol] ]← Acquire [ [symbol] , [symbol] ] samples by query function [symbol] on model f, data [symbol] [symbol] ←Annotate acquired samples [symbol] by human [symbol] = [symbol] ∪ [symbol] Execute prompt retrieval from [symbol] [symbol] ←Annotate acquired samples [symbol] by LLMs [symbol] = [symbol] ∪ [symbol] [symbol] = [symbol] \ [symbol] f (xᵢ; θ^{(r)})←Fine-tune f (xᵢ; θ^{(r)}) on [symbol] f (x; θ^{(r)}),

[symbol]

The multi-fidelity learning process may be stopped if either of the two stopping criteria is satisfied: (1) Annotation budget [symbol] : if the annotation budget after R rounds is greater than the total budget limit, i.e., [symbol] + [symbol] ≥ [symbol] , the interactive process is terminated; (2) Computational cost [symbol] : Compared with inference and query calculation cost, the computation cost of each fine-tuning round [symbol] is typically much more expensive and thus the fine-tuning process may be stopped if R× [symbol] ≥ [symbol] . Finally, certain embodiments involve returning the fine-tuned target LM f (x; θ^{(r)}) and annotated sample set [symbol] .

Certain embodiments involve use of the exploration-exploitation (EEQ) strategy, such as described with respect to FIG. 3. Specifically, certain embodiments involve applying a k-means cluster algorithm to embeddings of the sub-sampled unannotated data [symbol] . Based on the annotation budget, certain embodiments involve setting k= [symbol] /2^{r}+ [symbol] /R as the clustering parameters and identifying the cluster centers (or samples closets to the cluster center) as selected samples, thus enforcing diversity exploration. The uncertainty score for all selected samples is then calculated, and the uncertainty scores are ranked from high to low. The top [symbol] /2^{r} uncertain samples, in an example, are assigned to the human annotator following the least confidence strategy:

$${x}_{i}^{*} = arg {max}_{{x}_{i}} [ 1 - p ( {y}_{i} \vert {x}_{i} ; f ( {x}_{i} ; {θ}^{( r )} ) ) ] , \qquad ( 4 )$$

which has shown to be simple and effective in a variety of settings, resulting in enforcing uncertainty exploitation. Certain embodiments then involve updating the human-annotated pool [symbol] , which enables retrieval of a few examples as in-context examples for the LLM annotator, which can annotate [symbol] /R samples with better quality and stability.

Experimental results confirm that embodiments of the present disclosure provide significant performance improvements. For example, in certain experiments, the active multifidelity learning techniques described herein outperform model-only annotation (e.g., techniques in which only automated annotation by a model is used) in absolute gain by large margins, such as ranging from 6.89% to 19.95% depending on the problem domain.

### Example Operations for Active Multifidelity Machine Learning

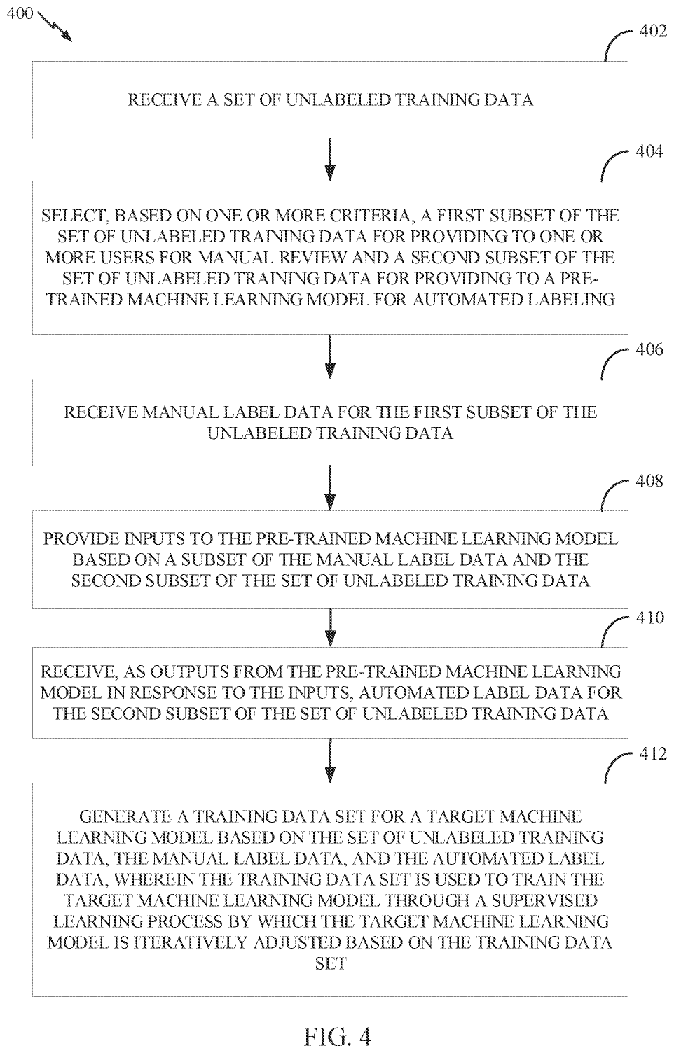

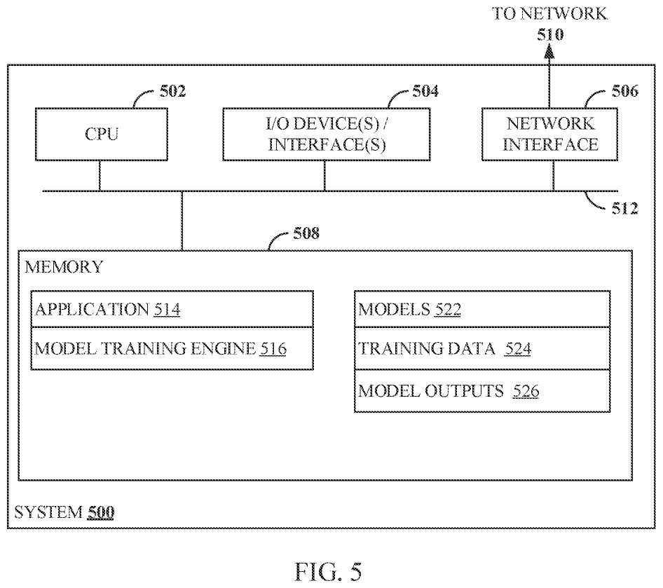

FIG. 4 depicts example operations 400 for active multifidelity machine learning. For example, operations 400 may be performed by one or more components of system 500 of FIG. 5, described below, such as model training engine 516.

Operations 400 begin at step 402, with receiving a set of unlabeled training data.

Operations 400 continue at step 404, with selecting, based on one or more criteria, a first subset of the set of unlabeled training data for providing to one or more users for manual review and a second subset of the set of unlabeled training data for providing to a pre-trained machine learning model for automated labeling.

In some embodiments, the selecting, based on the one or more criteria, the first subset of the set of unlabeled training data for providing to the one or more users for manual review and the second subset of the set of unlabeled training data for providing to the pre-trained machine learning model for automated labeling is based on confidence scores output by the target machine learning model in response to respective unlabeled training data instances of the set of unlabeled training data.

In certain embodiments, the selecting, based on the one or more criteria, the first subset of the set of unlabeled training data for providing to the one or more users for manual review and the second subset of the set of unlabeled training data for providing to the pre-trained machine learning model for automated labeling is based further on applying a clustering algorithm to at least a subset of the set of unlabeled training data. For example, the first subset of the set of unlabeled training data and the second subset of the set of unlabeled training data may correspond to central points of clusters determined through the applying of the clustering algorithm.

In some embodiments, the subset of the manual label data is selected based on comparing embeddings of respective unlabeled training data instances in the first subset of the set of unlabeled training data to corresponding embeddings of given unlabeled training data instances in the second subset of the set of unlabeled training data.

In certain embodiments, the first subset of the set of unlabeled training data is smaller than the second subset of the set of unlabeled training data.

Operations 400 continue at step 406, with receiving manual label data for the first subset of the set of unlabeled training data.

Operations 400 continue at step 408, with providing inputs to the pre-trained machine learning model based on a subset of the manual label data and the second subset of the set of unlabeled training data.

Operations 400 continue at step 410, with receiving, as outputs from the pre-trained machine learning model in response to the inputs, automated label data for the second subset of the set of unlabeled training data.

In some embodiments, the pre-trained machine learning model uses the manual label data for in-context learning when generating the automated label data for the second subset of the set of unlabeled training data.

Operations 400 continue at step 412, with generating a training data set for a target machine learning model based on the set of unlabeled training data, the manual label data, and the automated label data, wherein the training data set is used to fine-tune the target machine learning model through a supervised learning process by which the target machine learning model is iteratively adjusted based on the training data set.

In certain embodiments, the pre-trained machine learning model has a larger number of parameters than the target machine learning model.

In certain embodiments, in a subsequent round of generating labeled training data, a respective subset of unlabeled training data is selected for manual labeling, and the respective subset is smaller than the first subset of the set of unlabeled training data.

Notably, method 400 is just one example with a selection of example steps, but additional methods with more, fewer, and/or different steps are possible based on the disclosure herein.

### Example Computing System

FIG. 5 illustrates an example system 500 with which embodiments of the present disclosure may be implemented. For example, system 500 be configured to perform one or more of operations 400 of FIG. 4.

System 500 includes a central processing unit (CPU) 002, one or more I/O device interfaces 004 that may allow for the connection of various I/O devices 014 (e.g., keyboards, displays, mouse devices, pen input, etc.) to the system 500, network interface 506, a memory 508, and an interconnect5. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes an application 514, which may be a software application that performs one or more actions based on inferences generated using machine learning models (e.g., target machine learning model 110) that are trained according to techniques described herein, such as sending content from a serve-side application 514 to client-side applications on client devices or performing a wide variety of other actions (e.g., classifying data, recommending an action to a user, generating an alert or notification, and/or the like). Memory 508 further includes model training engine 616, which may perform actions described herein related to active multifidelity machine learning, such as with respect to FIGS. 1-4, including performing one or more of operations 400 of FIG. 4.

Memory 508 further comprises models 522, which may include target machine learning model 110 and/or pre-trained machine learning model 140 of FIG. 1, and/or one or more other models such as an embedding model. In alternative embodiments, one or more components such as pre-trained machine learning model 140 of FIG. 1 run on a remote computing device, such as a cloud server. Memory 508 further comprises training data 524, which may include manually labeled data 150 and model labeled data 160 of FIG. 1. Memory 508 further comprises model outputs 526, which include outputs from models 522, such as inferences (e.g., predicted labels), confidence scores, embeddings, and/or the like.

It is noted that one or more components described with respect to system 500 may alternatively or additionally be located on one or more separate computing devices. Furthermore, functionality described herein may be performed by more or fewer components than those depicted in system 500 of FIG. 5. For example, model training and/or fine-tuning may be performed using multiple CPUs and/or graphics processing units (GPUs) on one or more computing devices.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for active multifidelity machine learning, comprising:
receiving a set of unlabeled training data;
selecting, based on one or more criteria, a first subset of the set of unlabeled training data for providing to one or more users for manual review and a second subset of the set of unlabeled training data for providing to a pre-trained machine learning model for automated labeling;
receiving manual label data for the first subset of the set of unlabeled training data;
providing inputs to the pre-trained machine learning model based on a subset of the manual label data and the second subset of the set of unlabeled training data;
receiving, as outputs from the pre-trained machine learning model in response to the inputs, automated label data for the second subset of the set of unlabeled training data; and
generating a training data set for a target machine learning model based on the set of unlabeled training data, the manual label data, and the automated label data, wherein the training data set is used to fine-tune the target machine learning model through a supervised learning process by which the target machine learning model is iteratively adjusted based on the training data set.

2. The method of claim 1, wherein the selecting, based on the one or more criteria, the first subset of the set of unlabeled training data for providing to the one or more users for manual review and the second subset of the set of unlabeled training data for providing to the pre-trained machine learning model for automated labeling is based on confidence scores output by the target machine learning model in response to respective unlabeled training data instances of the set of unlabeled training data.

3. The method of claim 2, wherein the selecting, based on the one or more criteria, the first subset of the set of unlabeled training data for providing to the one or more users for manual review and the second subset of the set of unlabeled training data for providing to the pre-trained machine learning model for automated labeling is based further on applying a clustering algorithm to at least a subset of the set of unlabeled training data.

4. The method of claim 3, wherein the first subset of the set of unlabeled training data and the second subset of the set of unlabeled training data correspond to central points of clusters determined through the applying of the clustering algorithm.

5. The method of claim 1, wherein the pre-trained machine learning model has a larger number of parameters than the target machine learning model.

6. The method of claim 1, wherein the subset of the manual label data is selected based on comparing embeddings of respective unlabeled training data instances in the first subset of the set of unlabeled training data to corresponding embeddings of given unlabeled training data instances in the second subset of the set of unlabeled training data.

7. The method of claim 1, wherein the first subset of the set of unlabeled training data is smaller than the second subset of the set of unlabeled training data.

8. The method of claim 1, wherein, in a subsequent round of generating labeled training data, a respective subset of unlabeled training data is selected for manual labeling, and the respective subset is smaller than the first subset of the set of unlabeled training data.

9. The method of claim 1, wherein the pre-trained machine learning model uses the manual label data for in-context learning when generating the automated label data for the second subset of the set of unlabeled training data.

10. A system for active multifidelity machine learning, comprising:
one or more processors; and
a memory storing instructions that, when executed by the one or more processors, cause the system to:
receive a set of unlabeled training data;
select, based on one or more criteria, a first subset of the set of unlabeled training data for providing to one or more users for manual review and a second subset of the set of unlabeled training data for providing to a pre-trained machine learning model for automated labeling;
receive manual label data for the first subset of the set of unlabeled training data;
provide inputs to the pre-trained machine learning model based on a subset of the manual label data and the second subset of the set of unlabeled training data;
receive, as outputs from the pre-trained machine learning model in response to the inputs, automated label data for the second subset of the set of unlabeled training data; and
generate a training data set for a target machine learning model based on the set of unlabeled training data, the manual label data, and the automated label data, wherein the training data set is used to fine-tune the target machine learning model through a supervised learning process by which the target machine learning model is iteratively adjusted based on the training data set.

11. The system of claim 10, wherein the selecting, based on the one or more criteria, the first subset of the set of unlabeled training data for providing to the one or more users for manual review and the second subset of the set of unlabeled training data for providing to the pre-trained machine learning model for automated labeling is based on confidence scores output by the target machine learning model in response to respective unlabeled training data instances of the set of unlabeled training data.

12. The system of claim 11, wherein the selecting, based on the one or more criteria, the first subset of the set of unlabeled training data for providing to the one or more users for manual review and the second subset of the set of unlabeled training data for providing to the pre-trained machine learning model for automated labeling is based further on applying a clustering algorithm to at least a subset of the set of unlabeled training data.

13. The system of claim 12, wherein the first subset of the set of unlabeled training data and the second subset of the set of unlabeled training data correspond to central points of clusters determined through the applying of the clustering algorithm.

14. The system of claim 10, wherein the pre-trained machine learning model has a larger number of parameters than the target machine learning model.

15. The system of claim 10, wherein the subset of the manual label data is selected based on comparing embeddings of respective unlabeled training data instances in the first subset of the set of unlabeled training data to corresponding embeddings of given unlabeled training data instances in the second subset of the set of unlabeled training data.

16. The system of claim 10, wherein the first subset of the set of unlabeled training data is smaller than the second subset of the set of unlabeled training data.

17. The system of claim 10, wherein, in a subsequent round of generating labeled training data, a respective subset of unlabeled training data is selected for manual labeling, and the respective subset is smaller than the first subset of the set of unlabeled training data.

18. The system of claim 10, wherein the pre-trained machine learning model uses the manual label data for in-context learning when generating the automated label data for the second subset of the set of unlabeled training data.

19. A non-transitory computer-readable medium comprising instructions that, when executed by one or more processors of a computing system, cause the computing system to:
receive a set of unlabeled training data;
select, based on one or more criteria, a first subset of the set of unlabeled training data for providing to one or more users for manual review and a second subset of the set of unlabeled training data for providing to a pre-trained machine learning model for automated labeling;
receive manual label data for the first subset of the set of unlabeled training data;
provide inputs to the pre-trained machine learning model based on a subset of the manual label data and the second subset of the set of unlabeled training data;
receive, as outputs from the pre-trained machine learning model in response to the inputs, automated label data for the second subset of the set of unlabeled training data; and
generate a training data set for a target machine learning model based on the set of unlabeled training data, the manual label data, and the automated label data, wherein the training data set is used to fine-tune the target machine learning model through a supervised learning process by which the target machine learning model is iteratively adjusted based on the training data set.

20. The non-transitory computer-readable medium of claim 19, wherein the selecting, based on the one or more criteria, the first subset of the set of unlabeled training data for providing to the one or more users for manual review and the second subset of the set of unlabeled training data for providing to the pre-trained machine learning model for automated labeling is based on confidence scores output by the target machine learning model in response to respective unlabeled training data instances of the set of unlabeled training data.
